(19) United States
(12) Patent Application Publication
(10) Pub. No.: US 2016/0073833 A1
(43) Pub. Date: Mar. 17, 2016

(54) MULTI-CHAMBER REFILL UNIT AND DISPENSERS

(71) Applicant: GOJO Industries, Inc., Akron, OH (US)

(72) Inventors: Nick E. Ciavarella, Seven Hills, OH (US); Thomas A. Marting, Wadsworth, OH (US)

(21) Appl. No.: 14/848,708

(22) Filed: Sep. 9, 2015

Related U.S. Application Data
(60) Provisional application No. 62/049,412, filed on Sep. 12, 2014.

(51) Int. Cl. A47K 5/14; A47K 5/12; B29C 65/00; B05B 11/00

(52) U.S. Cl. CPC A47K 5/14; B05B 11/0037; A47K 5/1211; B05B 11/3087; B29C 65/002; B29L 2031/7496

(57) ABSTRACT

Exemplary embodiments of refill units and dispensers are provided herein. An exemplary refill unit or dispenser includes an air pump portion having a flexible plastic portion that includes a first side and a second side, an inlet valve, a foam located between the first side and the second side and an air outlet valve. A liquid pump portion is included that has a flexible plastic portion that includes a first side and a second side, a liquid inlet, a foam located between the first side and the second side and a liquid outlet valve for allowing liquid out of the liquid pump portion is included. A foaming chamber is located downstream of the liquid outlet valve and the air outlet valve. The foaming chamber has a flexible plastic portion having a first side and a second side, and an open cell foam located there between.

### RELATED APPLICATIONS

This application claims priority to and the benefits of U.S. Provisional Patent Application Ser. No. 62/049,412 filed on September 12, 2014 and entitled “MULTI-CHAMBER REFILL UNIT AND DISPENSERS,” which is incorporated herein by reference in its entirety.

### TECHNICAL FIELD

The present invention relates generally to foam pumps, refill units and dispenser systems and more particularly a multi-chamber refill units and dispenser.

### BACKGROUND OF THE INVENTION

Liquid dispenser systems, such as liquid soap and sanitizer dispensers, provide a user with an amount of foam upon actuation of the dispenser. Many foam pumps are disposed of with the refill unit when the refill unit is empty. The foam pumps typically include a number of parts, which increase the costs and the foam pumps are typically made of a material that is not readily compressible and does not readily decompose. As a result, such material may not be as environmentally favorable as one might desire.

### SUMMARY

Exemplary embodiments of refill units having multi-chamber pillow bag compartments and dispensers for dispensing foam from the refill units are provided herein. In some embodiments, the term refill unit is used to describe a foam pump and container for holding liquid. The refill units may also be used without a separate dispenser, and in that case may be referred to as a dispenser. Accordingly, the term refill unit and dispenser may be used interchangeably and a foam pump and container of foamable liquid may be a refill unit if it is used with a separate dispenser, or as a dispenser if used by itself.

An exemplary refill unit (or dispenser) includes a container formed by a flexible plastic, an air pump portion, a liquid pump portion, and a foaming chamber. The air pump portion includes a flexible plastic portion that has a first side and a second side. An air inlet valve is included for allowing air into the air pump portion. Foam is located between the first side and the second side. The foam biases the first side and the second side away from one another. An air outlet valve is included for allowing air out of the air pump portion. In addition, a liquid pump portion is included. The liquid pump portion includes a flexible plastic portion that has a first side and a second side. A liquid inlet valve for allowing liquid into the liquid pump portion is included. In addition, foam located between the first side and the second side. The foam biases the first side and the second side away from one another. A liquid outlet valve for allowing liquid out of the liquid pump portion is included. A foaming chamber is located downstream of the liquid outlet valve and the air outlet valve. The foaming chamber has a flexible plastic portion that has a first side and a second side. Open cell foam is located between the first side and the second side. The open cell foam is located so that liquid flowing out of the liquid pump portion and air flowing out of the air pump portion flow through the open cell foam in the foaming chamber prior to flowing out of an outlet.

Methods of making foam pumps are also disclosed herein. An exemplary method of making foam pump include obtaining a bottom layer of plastic, arranging one or more pieces of foam on the bottom layer of plastic. The exemplary method of making a foam pump also includes arranging a liquid inlet valve, a liquid outlet valve, an air inlet valve and an air outlet valve on the bottom layer of plastic and arranging a top layer of plastic over the one or more pieces of foam and one or more valves. In addition, the exemplary methodology includes joining the bottom layer of plastic to the top layer of plastic to form a multi-chamber foam pump and container.

Another exemplary refill unit (or dispenser) includes a container and a foam pump connected to the container. The foam pump has an air pump chamber having foam located therein, a liquid pump chamber having foam located therein, and a foaming chamber having an open cell foam located therein and an outlet.

In this way, simple and economical multi-chamber pillow bag refill units and dispensers are provided.

### BRIEF DESCRIPTION OF THE DRAWINGS

These and other features and advantages of the present invention will become better understood with regard to the following description and accompanying drawings in which:

FIG. 1 is a front elevational view of an exemplary foam dispenser having a refill unit located inside; and

FIG. 2 is a cross-sections of an exemplary embodiment of refill unit or dispenser; and

FIG. 3 is a cross-section of another exemplary embodiment of a refill unit or dispenser.

### DETAILED DESCRIPTION

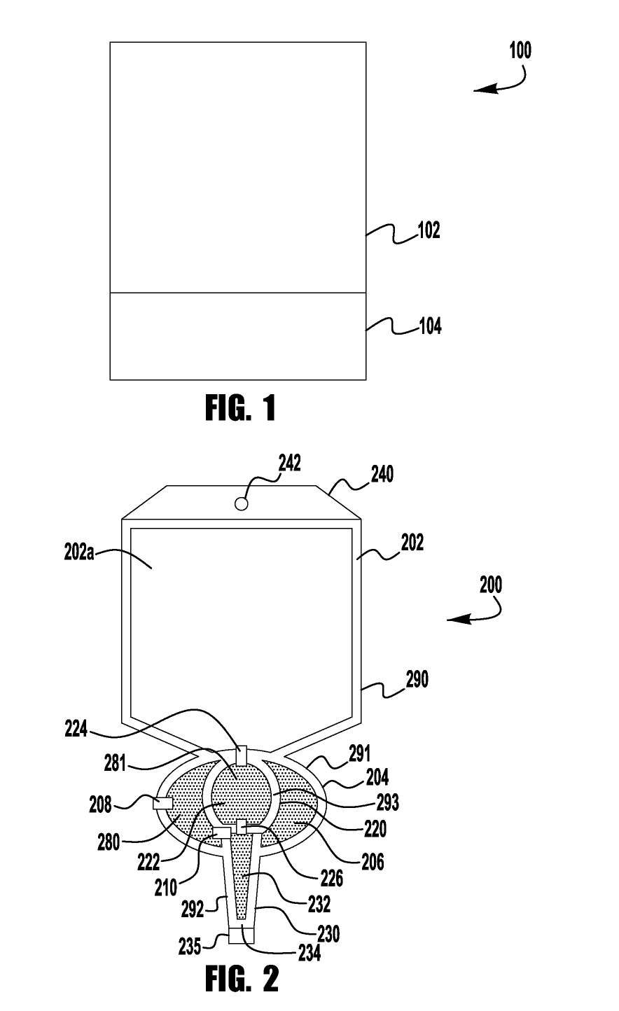

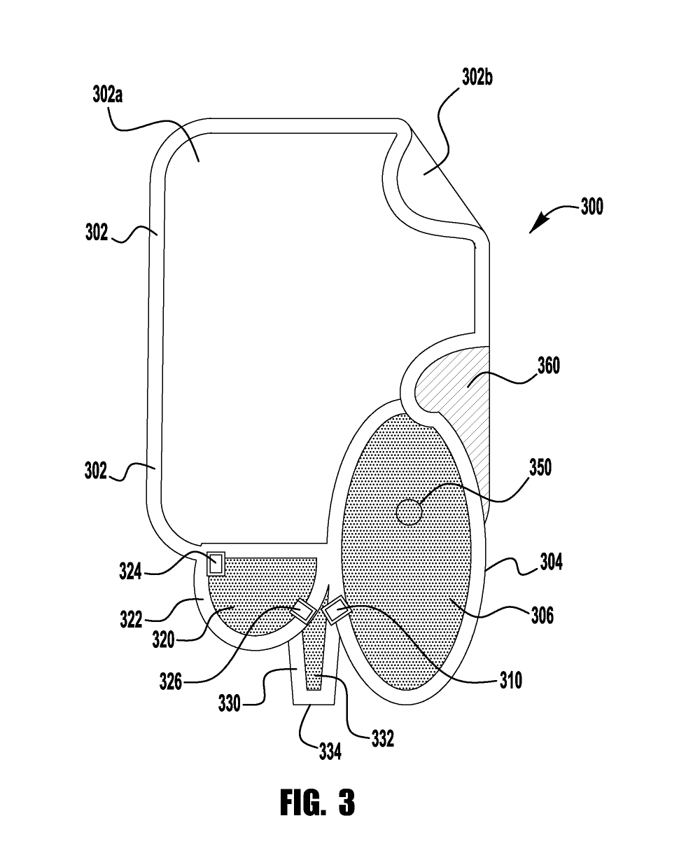

FIG. 1 illustrates an exemplary embodiment of a foam dispenser 100 having a housing 102 and an actuating member 104, such as, for example, a horizontally activated push-bar. Movement of actuating member 104 causes foam to be dispensed to a user. Dispenser 100 includes a disposable refill unit (exemplary refill units are disclosed with respect to FIGS. 2 and 3) is placed inside dispenser 100. The refill unit includes a container having a foamable liquid, an air pump, a liquid pump, a mixing chamber and an outlet. The dispenser 100 may be a wall-mounted system, a counter-mounted system, an un-mounted portable system movable from place to place or any other kind of liquid dispenser system. In various embodiments, the foamable liquid may be, for example, a soap, a sanitizer, a cleanser, a disinfectant, a lotion or the like.

In the event the liquid stored in the installed disposable refill unit runs out or the installed refill unit otherwise has a failure, the installed refill unit may be removed from the foam dispenser 100. The empty or failed disposable refill unit may then be replaced with a new disposable refill unit.

As used herein, actuator, actuator member or mechanisms include one or more parts that cause the dispenser 100 to move liquid, air and/or foam by compressing the liquid pump chamber and the air pump chamber. Actuator 104 is generically illustrated because there are many different kinds of actuators which may be employed in the foam dispenser 100. The actuator 104 of the foam dispenser 100 may be any type of actuator such as, for example, a manual lever, a manual pull bar, a manual push bar, a manual rotatable crank, an electrically activated actuator or other means for actuating the pump 120. Electronic actuators may additionally include a sensor for detecting the presence of an object and to provide for a hands-free dispenser system with touchless operation. Various intermediate linkages, may be used to ensure that movement of actuating member 104 causes a liquid pump and an air pump to dispense their contents.

FIG. 2 is an exemplary embodiment of a refill unit 200. Refill unit 200 includes a container 202 for holding a foamable liquid, an air pump 204, a liquid pump 220, a mixing chamber 230 and an outlet 234. In this exemplary embodiment, the container 202 is made of a thin plastic or film, such as thermoplastic film or the like. The container 202 (as well as the liquid pump 220, air pump 204, mixing chamber 230 and outlet 234) may be made by welding, bonding, heat sealing, adhering, etc. two pieces of thin plastic or film together. In some embodiments, container 202 includes a flap 240 formed in the thin plastic of film. Flap 240 may have an aperture 242 therethrough. Aperture 242 may be used to mount refill unit 200 in dispenser 100. In some embodiments, refill unit 200 is a complete dispenser in its self. In some embodiments, the refill unit 200, when used as a dispenser itself, is attached to a mounting mechanism, such as, for example, a hook.

Refill unit 200 includes an air pump 204. Air pump 204 includes an air inlet check valve 208 and an air outlet check valve 210. The check valves, identified and disclosed herein may be any suitable check valve, such as, for example, a flat valve, a duck bill valve, and the like. A suitable duck bill valve may be found in U.S. Pat. No. 5,144,708, which is incorporated herein in its entirety. In some embodiments, air pump 204 may also be made of one or more sheets of the same thin plastic or film that makes up container 202. Located within air pump 204 is a biasing media 206. Biasing media 206 urges the two pieces of thin plastic or film that make up the air pump 204 away from one another. In this exemplary embodiment, biasing media 206 is a foam, and in some embodiments an open cell foam material. In embodiments where a closed cell foam is used to bias the air pumps (and the liquid pumps described below) a low or medium density closed cell polyurethane, neoprene, PE, or the like may function as a biasing medium. In the case of a foam material, air may flow around the foam, and in the case of an open cell foam air may also flow through the foam. In the case of foam or open cell foam, the uncompressed thickness of the open cell foam should be selected to bias the two pieces of thin plastic away from one another. The thicker the uncompressed thickness of the foam or open cell foam, the more the biasing pressure. Various applications may require higher or lower biasing pressures.

In addition, refill unit 200 includes a liquid pump 220. Liquid pump 220 includes a liquid inlet check valve 224 and a liquid outlet check valve 226. As described above, the liquid inlet check valve 224 and liquid outlet check valve 226 may be any type of check valve, such as, for example, a duck bill valve, a flat valve, or the like. In some embodiments, the liquid check valves are made of thermoplastic. Liquid pump 220 may also be made of one or more sheets of the same thin plastic or film that makes up container 202. Located within liquid pump 220 is a biasing media 222. Biasing media 222 urges the two pieces of thin plastic or film that make up the liquid pump 220 away from one another. In this exemplary embodiment, biasing media 222 is a foam or an open cell foam material. In the case of a foam, liquid may flow around the foam and in the case of an open cell foam, liquid may also flow through the foam. Biasing media 222 may be selected so that the two pieces of thin plastic or film that make up the liquid pump 220 are biased away from one another with enough force to draw in foamable liquid from container 202 at a speed sufficient to replenish the fluid in liquid pump 220 at a rate suitable for a desired dispense rate.

A mixing chamber 230 is located downstream of the air pump 204 and liquid pump 220. The mixing chamber is also made of the thin plastic or film material making up the other components. Mixing chamber 230 includes mix media 230 for causing turbulence to liquid and air passing out of the liquid pump 220 and air pump 204 as it flows through the mix media. Mix media 230 is also an open cell foam material. In some embodiments, the biasing media 206, biasing media 222 and mix media 230 are the same material. The open cell foam of mix media 230 also helps prevent dripping of residual fluid after a dose of foam is output from the outlet 234. In addition, the open cell form and the elastic nature of the mixing chamber 230 and outlet 234 help to prevent clogging and splashing.

A foam outlet 234 is located at the end of the mixing chamber 230. In some embodiments, a shipping seal 235 seals foam outlet 234 while the product is being shipped or stored. Shipping seal 235 may include perforations (not shown) so that shipping seal 235 is a tear-way shipping seal. In some embodiments, shipping seal 235 is cut off or ripped off.

In this exemplary embodiment, air pump 204 at least partially surrounds liquid pump 220. The volume of air pump 204 and liquid pump 220 may be sized to have a ratio of, for example, between about 2 to 1, about 5 to 1, about 7 to 1, about 10 to 1.

If refill unit 200 is used in a dispenser, such as, for example, the dispenser housing shown in FIG. 1, pushing actuator 104 inward compressed liquid pump chamber 220 causing fluid to flow out of liquid pump chamber 220 past one-way liquid outlet valve 226 and into mixing nozzle 292. Simultaneously, air pump chamber 204 is compressed causing air to flow out of air pump chamber 204 and into mixing nozzle 292. The liquid and air mix together and as they are forced through the open cell foam, the liquid and air mixture form a rich foam that is dispensed out of outlet 234. In some embodiments, refill unit 200 is a dispenser. In such a case, the dispenser may be stationary, and mounted to a hook via aperture 242. In some embodiments, refill unit 200 is a small personal dispenser. In either case, a user that desires the foam output need only compress both the air pump chamber 204 and the liquid pump chamber 220 to obtain a dose of foam product.

In some embodiments, a user may not want foam, but rather just a shot of liquid. In such a case, the user need only compress the liquid pump portion 220 and not the air pump chamber 204.

In some embodiments, the refill unit 200 may be fabricated by layering a first piece of film 202a, one or more layers of foam or open cell foam 280, 281, a plurality of one-way valves 208, 210, 224 and 226 and a second piece of film (not shown). In some embodiments, the foam or open cell foam contains cutouts for receiving and holding the one-way valves, 210, 224 and 226 in place. A sealing means, such as for example, a thermal welding machine is used to join the first film 202a to the second film along seals 290, 291, 292, 293 to create container 202, liquid pump 281, and air pump 280. In some embodiments, the thermal welding machine also includes one or more cutting edges to cut away excess film or material.

FIG. 3 illustrates another exemplary embodiment of a foam dispenser 300. Foam dispenser 300 includes a container portion 302, a liquid pump portion 320, an air pump portion 304, a mixing chamber 330 and an outlet 334. A first film 302a located on one side and a second film 302b located on the other side are joined together to form foam dispenser or refill unit 300. The films may be joined to one another by any means, such as, for example, heat welding, adhesive, laser welding, or the like. Container 302 includes a gripping region 360 which consists of film 302a and film 302b secured to one another.

Liquid pump chamber 320 includes a biasing member 322, which may be, for example, a foam or an open cell foam as described above. Liquid pump chamber 320 includes a one-way liquid inlet valve 324 and a one-way liquid outlet valve 326. The liquid inlet and outlet valves 324, 326 may be any type of one-way valves as described above. Liquid inlet valve 324 places liquid pump chamber 320 in fluid communications with the interior of container 302 which is filled with a foamable liquid, such as, for example, a foamable soap or sanitizer. One-way liquid outlet valve 326 places liquid pump chamber 320 in fluid communication with mixing chamber 330. Mixing chamber 330 includes a mix media 332, which may be, for example, open cell foam.

Air pump chamber 304 includes a biasing member 306 to bias film 302a away from film 302b to expand the air pump chamber 304. Air pump chamber 304 includes an opening 350 and a one-way air outlet valve 310. One-way air outlet valve 310 places air pump chamber 304 in fluid communication with mixing chamber 330. Located within mixing chamber 330 is mix media 332 which may be a foam or an open cell foam. Mixing chamber 330 includes an outlet 334. Foam dispenser 300 may be made as described above with respect to foam dispenser 200. As use herein the term foam is broader ant open cell foam and includes open cell foam.

The embodiment illustrated in FIG. 3 may be used as a refill unit in a dispenser housing, or as a dispenser without a separate dispenser housing, and in some embodiments is a personal dispenser.

While the present invention has been illustrated by the description of embodiments thereof and while the embodiments have been described in considerable detail, it is not the intention of the applicant to restrict or in any way limit the scope of the appended claims to such detail. Additional advantages and modifications will readily appear to those skilled in the art. Therefore, the invention, in its broader aspects, is not limited to the specific details, the representative apparatus and illustrative examples shown and described. Accordingly, departures may be made from such details without departing from the spirit or scope of the applicant's general inventive concept.

We claim:

1. A dispenser or refill unit comprising:
a container formed by a thin flexible plastic;
an air pump portion;
the air pump portion having a first side made of thin flexible material and a second side made of thin flexible material;
an air inlet valve for allowing air into the air pump portion;
foam located between the first side and the second side;
the open cell foam biasing the first side and the second side away from one another;
an air outlet valve for allowing air out of the air pump portion;
a liquid pump portion;
the liquid pump portion having a first side made of thin flexible material and a second side made of thin flexible material;
a liquid inlet valve for allowing liquid into the liquid pump portion;
foam located between the first side and the second side;
the foam biasing the first side and the second side away from one another;
a liquid outlet valve for allowing liquid out of the liquid pump portion;
a foaming chamber located downstream of the liquid outlet valve and the air outlet valve;
the foaming chamber having a first side made of thin flexible material and a second side made of thin flexible material
open cell foam located between the first side and the second side;
the open cell foam located so that liquid flowing out of the liquid pump portion and air flowing out of the air pump portion flow through the open cell foam in the foaming chamber prior to flowing out of an outlet.

2. The dispenser or refill unit of claim 1 wherein the flexible plastic of the container, the flexible material of the air pump portion, the flexible material of the liquid pump portion, and the flexible material of the foaming chamber have the same properties.

3. The dispenser or refill unit of claim 1 wherein the air inlet valve and the air outlet valve are flat valves.

4. The dispenser or refill unit of claim 1 wherein the liquid inlet valve and the liquid outlet valve are flat valves.

5. The dispenser or refill unit of claim 1 wherein at least a portion of the liquid pump chamber is surrounded by the air pump chamber.

6. The dispenser or refill unit of claim 1 wherein the air pump chamber is offset from a centerline of the container.

7. The dispenser or refill unit of claim 1 further comprising a shipping seal across the outlet.

8. The dispenser or refill unit of claim 7 wherein the shipping is formed at least in part by the bottom layer of flexible material and the top layer of flexible material of the foaming chamber.

9. The dispenser or refill unit of claim 1 further comprising an aperture for hanging the dispenser or refill unit.

10. A method of making a dispenser or refill unit comprising:
obtaining a bottom layer of flexible material;
arranging one or more pieces of foam on the bottom layer of flexible material;
arranging a liquid inlet valve, a liquid outlet valve, an air inlet valve and an air outlet valve on the bottom layer of flexible material;
arranging a top layer of flexible material over the one or more pieces of foam and one or more valves; and
joining the bottom layer of flexible material to the top layer of flexible material to form a container, an air pump, a liquid pump, a foaming, and an outlet.

11. The method of making a dispenser or refill of claim 10 wherein joining the bottom layer of flexible material to the top layer of flexible material comprises use of heat.

12. The method of making a dispenser or refill of claim 11 wherein at least a portion of the foam is located in the air pump chamber, the liquid pump chamber and the foaming chamber and at least the portion of foam in the foaming chamber is an open cell foam.

13. The method of making a dispenser or refill of claim 10 wherein the air pump chamber at least partially surrounds the liquid pump chamber.

14. The method of making a dispenser or refill of claim 10 wherein the liquid pump chamber is located on a center line of the container.

15. The method of making a dispenser or refill of claim 10 wherein the air pump chamber offset from a center line of the container.

16. A dispenser or refill unit comprising:
a container;
a foam pump connected to the container;
the foam pump having an air pump chamber having foam located therein;
a liquid pump chamber having foam located therein;
a foaming chamber having open cell foam located therein; and
an outlet.

17. The dispenser or refill unit of claim 16 wherein the air pump chamber, the liquid pump chamber, and the foaming chamber have a first layer of flexible material on a first side of the foam and a second layer of flexible material on a second side of the foam, and wherein at least a portion of the first layer of flexible material is joined to the second layer of flexible material to form the air pump chamber, the liquid pump chamber and the foaming chamber.

18. The dispenser or refill unit of claim 17 further comprising an air inlet valve for allowing air into the air pump chamber and an air outlet valve for allowing air out of the air pump chamber; a liquid inlet valve for allowing liquid into the liquid pump chamber and a liquid outlet valve for allowing liquid out of the liquid pump chamber.

19. The dispenser or refill unit of claim 16 further comprising a shipping seal located proximate the outlet.

20. The dispenser or refill unit of claim 19 wherein the shipping seal is formed by at least one of the first layer of flexible material and the second layer of flexible material.
